(19) United States
(12) Patent Application Publication
(10) Pub. No.: US 2016/0301634 A1
(43) Pub. Date: Oct. 13, 2016

(54) CONTROLLING A DELIVERY OF MESSAGES TO DESIGNATED COMPUTING DEVICES

(71) Applicant: International Business Machines Corporation, Armonk, NY (US)

(72) Inventors: Corville O. Allen, Morrisville, NC (US); Mario A. Maldari, Longmont, CO (US); Paul A. Smith, Cary, NC (US)

(21) Appl. No.: 14/684,350

(22) Filed: Apr. 11, 2015

(51) Int. Cl. H04L 12/58

(52) U.S. Cl. CPC H04L 51/04; H04L 51/38; H04L 51/28

(57) ABSTRACT

A method, system and computer program product for controlling a delivery of messages to designated computing devices. A messaging server receives from a user message delivery information used to create a profile for each of the user's registered computing devices which contains details of criteria as to whether the registered computing device is able to receive a message from a sender. If the messaging server receives a message to be delivered to a recipient, then the messaging server reviews the profiles associated with the recipient to determine which, if any, of the recipient's computing devices are to receive a message from the sender. If a recipient's computing device is able to receive the message from the sender according to the profile, then the messaging server delivers the message to that computing device. In this manner, the user is able to control the delivery of messages to designated computing devices.

### TECHNICAL FIELD

The present invention relates generally to communications, and more particularly to controlling the delivering of messages (e.g., text messages, instant messages) to designated computing devices (e.g., iPad®, iPhone®).

### BACKGROUND

In this current age of mass communication and the ever growing prevalence of instant and text messaging, such communication is mostly device agnostic. For example, the sender of a message (e.g., instant message, text message) sends the message to all of the computing devices of the recipient (“receiver devices”) that are capable of receiving the message or are listening for the message.

In many situations, many users possess two or more computing devices (e.g., laptop computer, tablet, smartphone) that are capable of receiving messages (e.g., instant messages, text messages). If the user is logged onto all of these devices, then each of these devices may receive the message sent to this user from the sender.

However, the recipient of the message may not want each of the recipient's devices to receive a message from the sender. For example, if one of the recipient's computing devices is being used by the recipient's child and the message is personal (e.g., message from husband and wife) or business-related, then the recipient may not want the message to be sent to that device being used by the recipient's child.

Additionally, when a recipient receives a message, the recipient may receive a message regardless of the application that is currently being executed on the recipient's computing device. There may be some times when a recipient does not want to receive any messages when a particular application is executing. For example, if the recipient is playing a particular game with a friend, the recipient may not want to be interrupted with messages.

Furthermore, the sender does not have any ability to determine which computing device is more appropriate to receive a message from the sender, such as the device that the recipient desires to receive such a message. Hence, the recipient may receive a message on a computing device that the recipient desires not to receive such a message.

Currently, in attempting to address such issues, the user of a receiver device may be able to turn off the notification of receiving a message when a message (e.g., instant message, text message) is received by the device. However, the message is still being sent to that computing device. The user is just not being notified.

As a result, there is not currently a means for effectively controlling the delivering of messages to designated computing devices.

### BRIEF SUMMARY

In one embodiment of the present invention, a method for controlling a delivery of messages to designated computing devices comprises receiving identifiers of computing devices to be registered from a user. The method further comprises receiving, by a processor, message delivery information from the user to create a profile for each registered computing device which contains details of criteria as to whether the registered computing device is able to receive a message from a sender. The method additionally comprises delivering a message received from the sender to a registered computing device in response to the associated profile indicating that the registered computing device is able to receive the message from the sender. Furthermore, the method comprises preventing the message from being delivered to one or more other registered computing devices of the user that are actively receiving messages that are not eligible to receive the message from the sender according to the associated one or more profiles.

Other forms of the embodiment of the method described above are in a system and in a computer program product.

In another embodiment of the present invention, a method for controlling a delivery of messages to designated computing devices comprises receiving a designated recipient to receive a message being composed by a sender. The method further comprises receiving, by a processor, a designated computing device of the designed recipient to receive the message being composed by the sender. The method additionally comprises delivering the message being composed by the sender to the designated computing device of the designated recipient.

Other forms of the embodiment of the method described above are in a system and in a computer program product.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

A better understanding of the present invention can be obtained when the following detailed description is considered in conjunction with the following drawings, in which:

FIG. 1 illustrates a communication system configured in accordance with an embodiment of the present invention;

FIG. 2 illustrates a hardware configuration of a client device in accordance with an embodiment of the present invention;

FIG. 3 illustrates a hardware configuration of a messaging server in accordance with an embodiment of the present invention;

FIG. 4 is a flowchart of a method for controlling the delivering of messages to designated computing devices in accordance with an embodiment of the present invention;

FIG. 5 illustrates a registry of the messaging server storing delivery profiles in accordance with an embodiment of the present invention;

FIG. 6 illustrates an example of a delivery profile in accordance with an embodiment of the present invention;

FIG. 7 is a flowchart of a method for locking a registered computing device to a communication thread in accordance with an embodiment of the present invention;

FIG. 8 is a flowchart of an alternative method for controlling the delivering of messages to designated computing devices in accordance with an embodiment of the present invention;

FIG. 9 is a flowchart of a further alternative method for controlling the delivering of messages to designated computing devices in accordance with an embodiment of the present invention; and

FIG. 10 is a flowchart of a method for the sender to designate a computing device to receive a composed message in accordance with an embodiment of the present invention.

### DETAILED DESCRIPTION

The present invention comprises a method, system and computer program product for controlling a delivery of messages to designated computing devices. In one embodiment of the present invention, a messaging server receives identifiers (e.g., media access control address) of computing devices (e.g., laptop computer, smartphone) to be registered from a user. The messaging server further receives from the user message delivery information used to create a profile (“delivery profile”) for each of the user's registered computing devices which contains details of criteria as to whether the registered computing device is able to receive a message from a designated sender. For example, the delivery profile may include a sender profile containing a list of senders whose messages can be received by the associated registered computing device. If the messaging server receives a message to be delivered to a recipient, then the messaging server reviews the delivery profiles associated with the recipient of the message to determine which, if any, of the recipient's computing devices are able to receive a message from the sender. For example, if John is the intended recipient of the message, then the delivery profiles for John's iPhone® and iPad® are reviewed to determine which, if any, of John's computing devices are to receive a message from the sender. If a recipient's computing device is able to receive the message from the sender according to the delivery profile, then the messaging server delivers the message to that computing device. In this manner, the user of computing devices is able to control the delivery of messages to designated computing devices.

In the following description, numerous specific details are set forth to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

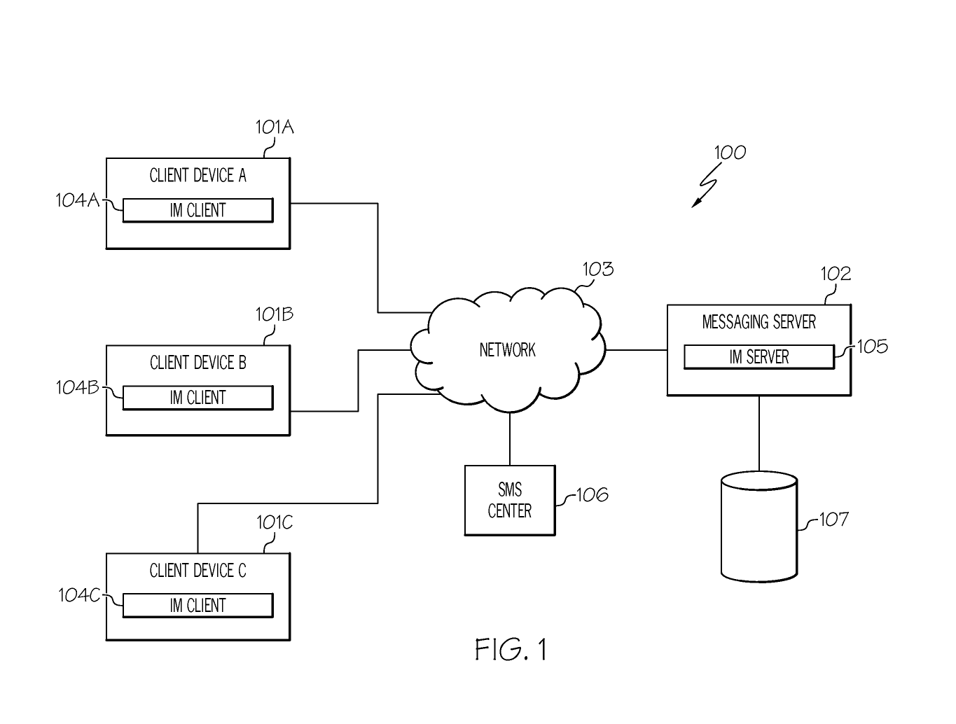

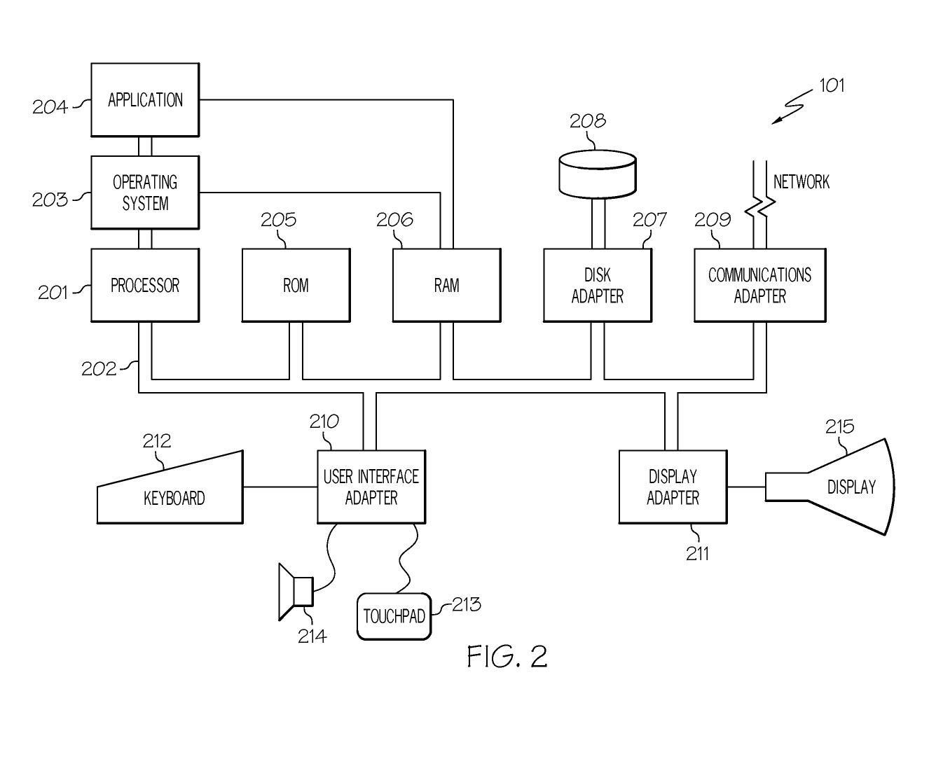

Referring now to the Figures in detail, FIG. 1 illustrates a communication system 100 for practicing the principles of the present invention in accordance with an embodiment of the present invention. Communication system 100 includes client devices (also referred to as “computing devices”) 101A-101C (identified as “Client Device A,” “Client Device B,” and “Client Device C,” respectively, in FIG. 1) connected to a messaging server 102 via a network 103. Client devices 101A-101C may collectively or individually be referred to as client devices 101 or client device 101, respectively. Client device 101 may be any type of computing device (e.g., portable computing unit, Personal Digital Assistant (PDA), smartphone, laptop computer, mobile phone, navigation device, game console, desktop computer system, workstation, Internet appliance and the like) configured with the capability of connecting to network 103 and consequently communicating with other client devices 101 and messaging server 102. Client device 101 may be configured to send and receive text-based messages in real-time during an instant messaging session. Any user of client device 101 may be the creator or initiator of an instant message (message in instant messaging) and any user of client device 101 may be a recipient of an instant message. Additionally, any user of client device 101 may be able to send and receive text messages, such as Short Message Services (SMS) messages. The term “messages,” as used herein, encompasses each of these types of messages. Furthermore, it is noted for clarity that one particular user may be a user of multiple client devices 101. For example, one particular user may be a user of both client device 101A and client device 101B. A description of the hardware configuration of client device 101 is provided below in connection with FIG. 2.

Network 103 may be, for example, a local area network, a wide area network, a wireless wide area network, a circuit-switched telephone network, a Global System for Mobile Communications (GSM) network, Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present invention.

In communication system 100, client devices 101A-101C include a software agent, referred to herein as an Instant Messaging (IM) client 104A-104C, respectively. Instant messaging clients 104A-104C may collectively or individually be referred to as instant messaging clients 104 or instant messaging client 104, respectively. Furthermore, messaging server 102 includes a software agent, referred to herein as the Instant Messaging (IM) server 105. IM client 104 provides the functionality to send and receive instant messages. As messages are received, IM client 104 presents the messages to the user in a dialog window (or IM window). Furthermore, IM client 104 provides the functionality for client device 101 to connect to the IM server 105 which provides the functionality of distributing the instant messages to the IM clients 104 associated with each of the sharing users.

System 100 further includes a Short Message Service (SMC) center 106 configured to relay, store and forward text messages, such as SMS messages, among client devices 101 through network 103.

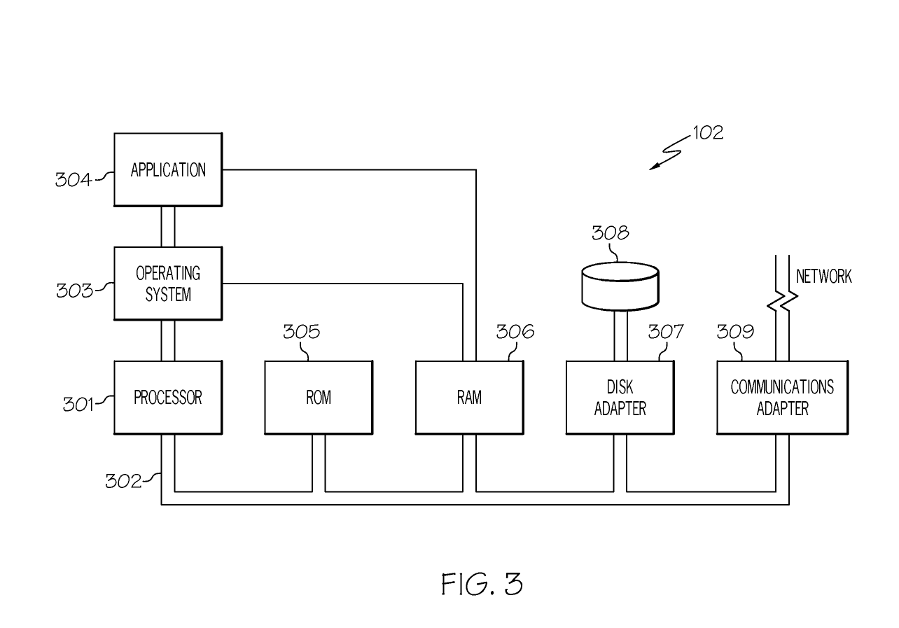

System 100 further includes a database 107 connected to messaging server 102. In one embodiment, database 107 stores profiles which contain criteria as to which computing device 101 (e.g., client device 101B) registered with messaging server 102 should receive a message from a designated sender (e.g., user of client device 101A). In one embodiment, each registered computing device 101 for a user is associated with a “delivery profile” which stores information, such as specifying whether the messages are to be sent to a most recently used registered computing device 101, specifying whether the messages from a particular sender are to be received by only a single registered computing device 101, specifying whether to keep a conversation thread started on a registered computing device 101 on only that registered computing device 101 until the conversation thread is specified as being completed or for a default period of time, a listing of applications and/or application types that when active cause messaging server 102 to prevent messages from being sent to the associated registered computing device 101, a listing of senders whose messages can be received by the associated registered computing device 101, a listing a conversation threads that are currently active on the associated registered computing device 101, an indication of the last activity and login, and a listing of designated message types to be delivered from designated senders. The delivery profile is not to be limited in scope to the information discussed above but may include any information that may be used to control the delivery of messages to the registered computing device 101. A more detailed description of the delivery profile is provided further below. A description of the hardware configuration of messaging server 102 is provided below in connection with FIG. 3.

System 100 is not to be limited in scope to any one particular network architecture. System 100 may include any number of client devices 101, messaging servers 102, networks 103, SMS centers 106 and databases 107. Furthermore, system 100 may include any number of users who possess any number of client devices 101 that potentially could receive messages. For example, a single user may possess client devices 101A-101B.

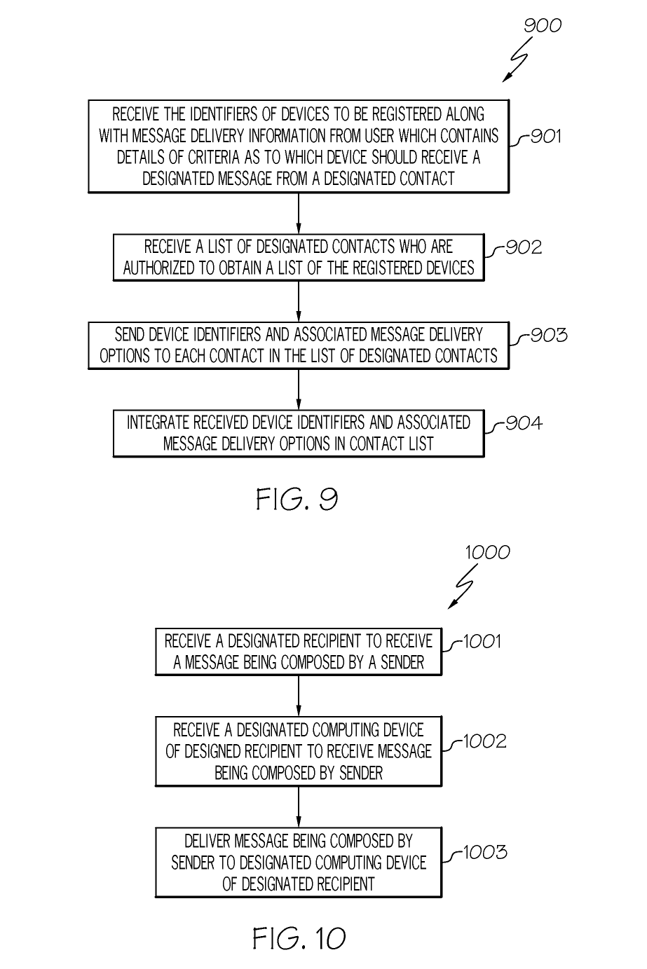

Referring now to FIG. 2, FIG. 2 illustrates a hardware configuration of client device 101 (FIG. 1) which is representative of a hardware environment for practicing the present invention. Referring to FIG. 2, client device 101 has a processor 201 coupled to various other components by system bus 202. An operating system 203 runs on processor 201 and provides control and coordinates the functions of the various components of FIG. 2. An application 204 in accordance with the principles of the present invention runs in conjunction with operating system 203 and provides calls to operating system 203 where the calls implement the various functions or services to be performed by application 204. Application 204 may include, for example, a program for controlling a delivery of messages to designated computing devices 101 by selecting a designated computing device 101 of a recipient of a composed message to receive the message as discussed further below in association with FIGS. 9-10.

Referring again to FIG. 2, read-only memory (“ROM”) 205 is coupled to system bus 202 and includes a basic input/output system (“BIOS”) that controls certain basic functions of client device 101. Random access memory (“RAM”) 206 and disk adapter 207 are also coupled to system bus 202. It should be noted that software components including operating system 203 and application 204 may be loaded into RAM 206, which may be client device's 101 main memory for execution. Disk adapter 207 may be an integrated drive electronics (“IDE”) adapter that communicates with a disk unit 208, e.g., disk drive.

Client device 101 may further include a communications adapter 209 coupled to bus 202. Communications adapter 209 interconnects bus 202 with an outside network (e.g., network 103 of FIG. 1) thereby enabling client device 101 to communicate with other client devices 101, messaging server 102 and SMS center 106.

I/O devices may also be connected to client device 101 via a user interface adapter 210 and a display adapter 211. Keyboard 212, touchpad 213 and speaker 214 may all be interconnected to bus 202 through user interface adapter 210. A display monitor 215 may be connected to system bus 202 by display adapter 211. In this manner, a user is capable of inputting to client device 101 through keyboard 212 or touchpad 213 and receiving output from client device 101 via display 215 or speaker 214. Other input mechanisms may be used to input data to client device 101 that are not shown in FIG. 2, such as display 215 having touch-screen capability and keyboard 212 being a virtual keyboard. Client device 101 of FIG. 2 is not to be limited in scope to the elements depicted in FIG. 2 and may include fewer or additional elements than depicted in FIG. 2.

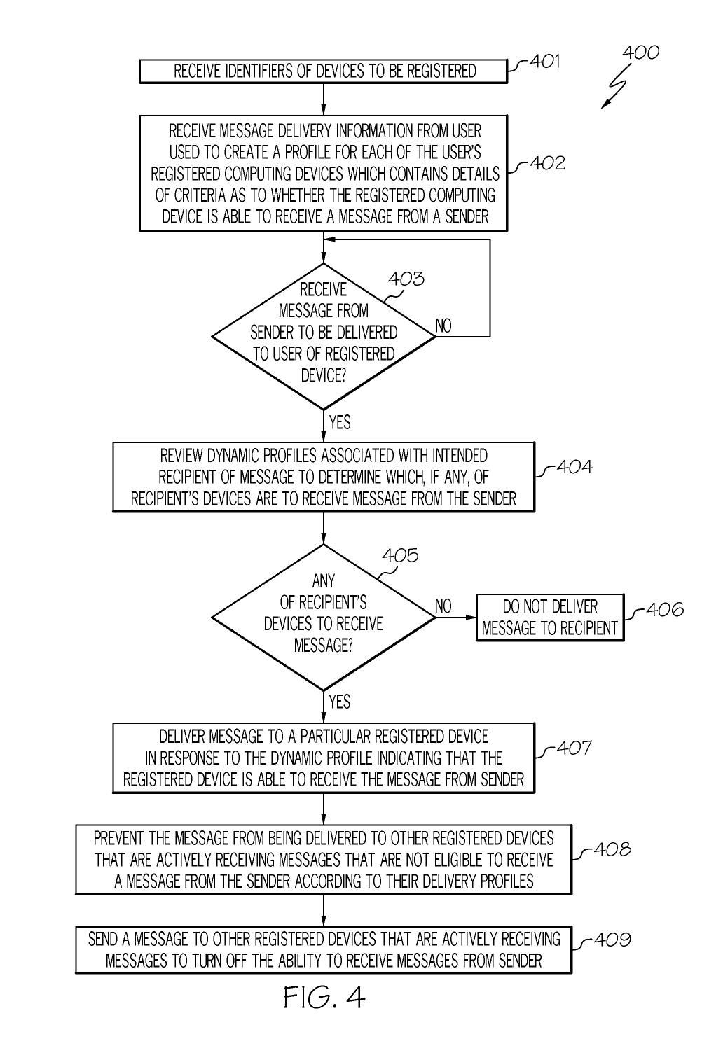

Referring now to FIG. 3, FIG. 3 illustrates a hardware configuration of messaging server 102 (FIG. 1) which is representative of a hardware environment for practicing the present invention. Referring to FIG. 3, messaging server 102 has a processor 301 coupled to various other components by system bus 302. An operating system 303 runs on processor 301 and provides control and coordinates the functions of the various components of FIG. 3. An application 304 in accordance with the principles of the present invention runs in conjunction with operating system 303 and provides calls to operating system 303 where the calls implement the various functions or services to be performed by application 304. Application 304 may include, for example, a program for controlling a delivery of messages to designated computing devices 101 (FIG. 1) as discussed further below in association with FIGS. 4-8.

Referring again to FIG. 3, read-only memory (“ROM”) 305 is coupled to system bus 302 and includes a basic input/output system (“BIOS”) that controls certain basic functions of messaging server 102. Random access memory (“RAM”) 306 and disk adapter 307 are also coupled to system bus 302. It should be noted that software components including operating system 303 and application 304 may be loaded into RAM 306, which may be messaging server's 102 main memory for execution. Disk adapter 307 may be an integrated drive electronics (“IDE”) adapter that communicates with a disk unit 308, e.g., disk drive. It is noted that the program for controlling a delivery of messages to designated computing devices 101, as discussed further below in association with FIGS. 4-8, may reside in disk unit 308 or in application 304.

Messaging server 102 may further include a communications adapter 309 coupled to bus 302. Communications adapter 309 interconnects bus 302 with an outside network (network 103 of FIG. 1) thereby enabling messaging server 102 to communicate with client devices 101.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated in the Background section, in many situations, many users possess two or more computing devices (e.g., laptop computer, tablet, smartphone) that are capable of receiving messages (e.g., instant messages, text messages). If the user is logged onto all of these devices, then each of these devices may receive the message sent to this user from the sender. However, the recipient of the message may not want each of the recipient's devices to receive a message from the sender. For example, if one of the recipient's computing devices is being used by the recipient's child and the message is personal (e.g., message from husband and wife) or business-related, then the recipient may not want the message to be sent to that device being used by the recipient's child. Additionally, when a recipient receives a message, the recipient may receive a message regardless of the application that is currently being executed on the recipient's computing device. There may be some times when a recipient does not want to receive any messages when a particular application is executing. For example, if the recipient is playing a particular game with a friend, the recipient may not want to be interrupted with messages. Furthermore, the sender does not have any ability to determine which computing device is more appropriate to receive a message from the sender, such as the device that the recipient desires to receive such a message. Hence, the recipient may receive a message on a computing device that the recipient desires not to receive such a message. Currently, in attempting to address such issues, the user of a receiver device may be able to turn off the notification of receiving a message when a message (e.g., instant message, text message) is received by the device. However, the message is still being sent to that computing device. The user is just not being notified. As a result, there is not currently a means for effectively controlling the delivering of messages to designated computing devices.

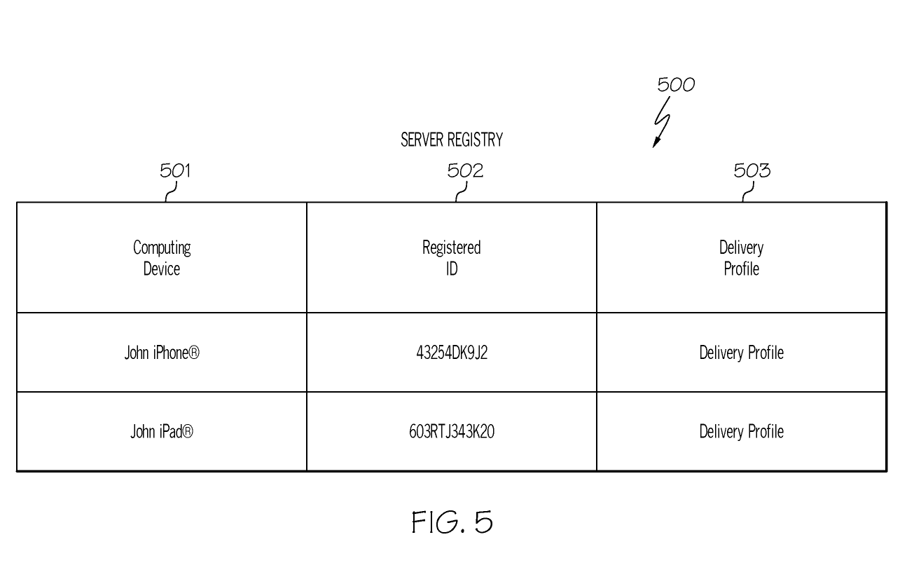

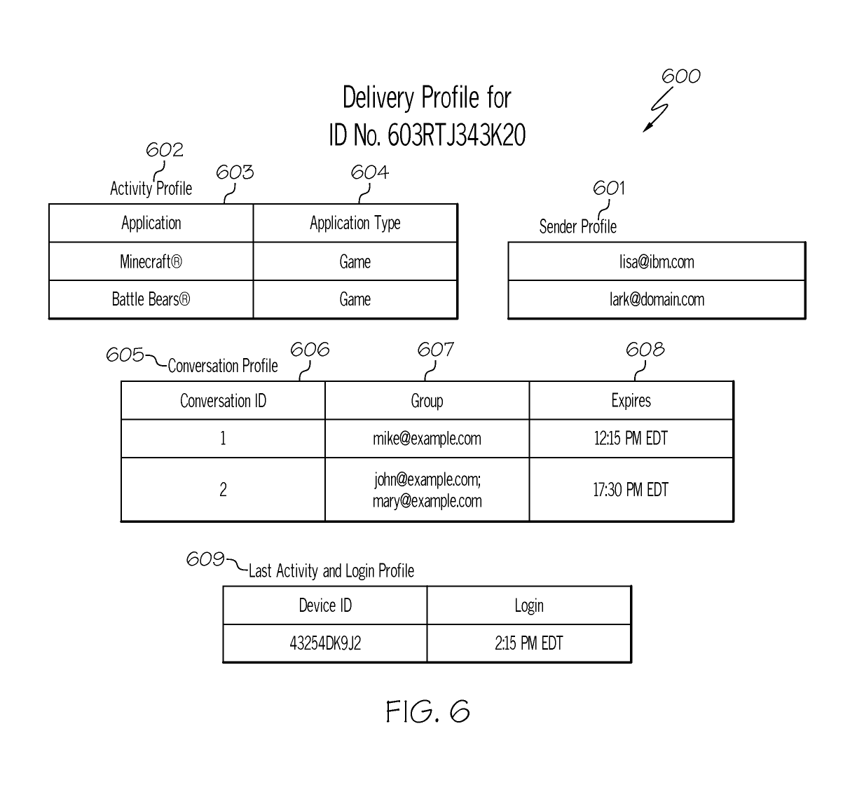

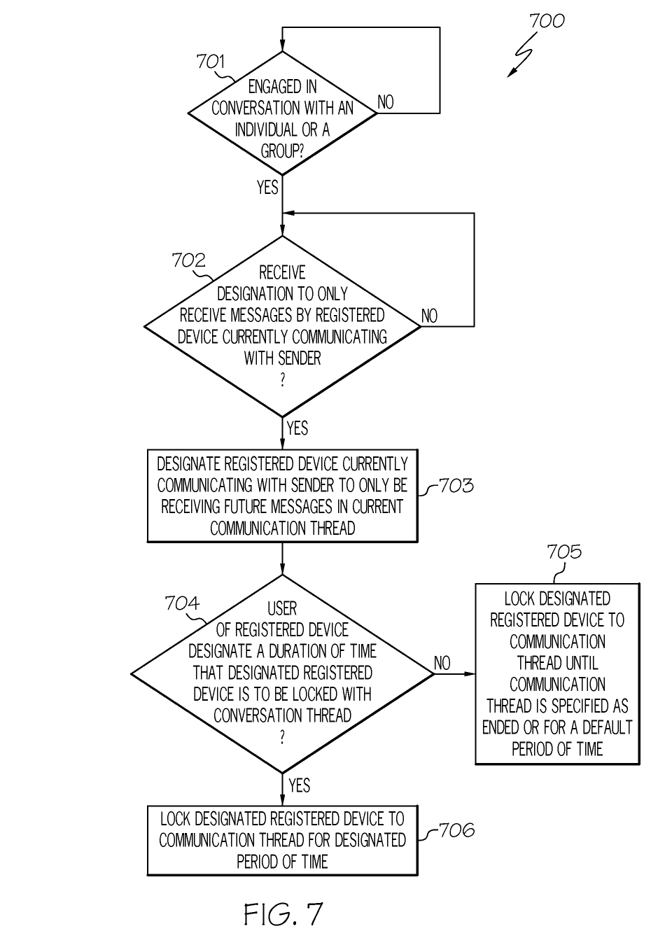

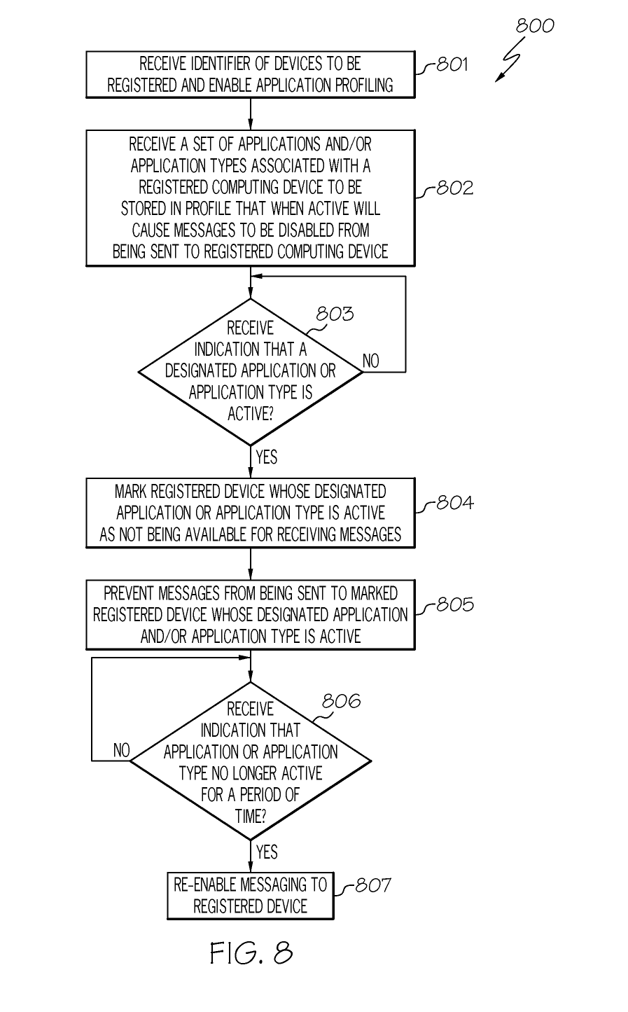

The principles of the present invention provide a means for effectively controlling the delivering of messages to designated computing devices 101 (FIG. 1) via the use of profiles (referred to herein as “delivery profiles”) as discussed below in connection with FIGS. 4-8 and via the ability of the sender to select the recipient device to receive the composed message of the sender as discussed below in connection with FIGS. 9-10. FIG. 4 is a flowchart of a method for controlling the delivering of messages to designated computing devices 101. FIG. 5 illustrates a registry of messaging server 102 (FIG. 1) storing delivery profiles. FIG. 6 illustrates an example of a delivery profile. FIG. 7 is a flowchart of a method for locking a registered computing device 101 to a communication thread. FIG. 8 is a flowchart of an alternative method for controlling the delivering of messages to designated computing devices 101. FIG. 9 is a flowchart of a further alternative method for controlling the delivering of messages to designated computing devices 101. FIG. 10 is a flowchart of a method for the sender to designate a computing device 101 to receive a composed message.

As stated above, FIG. 4 is a flowchart of a method 400 for controlling the delivering of messages to designated computing devices 101 in accordance with an embodiment of the present invention.

Referring to FIG. 4, in conjunction with FIGS. 1-3, in step 401, messaging server 102 receives identifiers of computing devices 101 to be registered from a user (e.g., user of client devices 101A). For example, the user of client device 101A provides messaging server 102 identifiers of two or more of the user's computing devices 101. In one embodiment, the identifier corresponds to a media access control (MAC) address. In one embodiment, such computing devices 101 are registered in a server registry as illustrated in FIG. 5.

FIG. 5 illustrates a registry 500 of messaging server 102 storing delivery profiles in accordance with an embodiment of the present invention. In one embodiment, registry 500 is stored in the memory or storage of messaging server 102 (e.g., memory 305, disk unit 308). As illustrated in FIG. 5, registry 500 stores a list 501 of computing devices 101 (e.g., John iPhone®, e.g., John iPad®) and a list 502 of the associated registered identifiers. For example, the identifier of 43254DK9J2 is associated with John iPhone® and the identifier of 603RTJ343K20 is associated with John iPad®. Additionally, as illustrated in FIG. 5, registry 500 stores a listing 503 of delivery profiles associated with each of the registered computing devices 101 as discussed below. These delivery profiles are associated with the user of the registered computing devices 101.

Referring to FIG. 4, in conjunction with FIGS. 1-3 and 5, in step 402, messaging server 102 receives message delivery information from the user (e.g., user of client device 101A) to create a profile (“delivery profile”) for each of the user's registered computing devices 101 which contains details of criteria as to whether the registered computing device 101 (e.g., client device 101A) is able to receive a message from a sender (e.g., user of client device 101C) as illustrated in FIG. 6.

FIG. 6 illustrates an example of a delivery profile 600 (e.g., delivery profile for the computing device 101 with the identifier of 603RTJ343K20) associated with a user and the user's computing device 101 in accordance with an embodiment of the present invention. Referring to FIG. 6, delivery profile 600 includes a sender profile 601 containing a list of senders (e.g., “lisa@ibm.com”; “lark@domain.com”) whose messages can be received by the associated registered computing device 101.

Delivery profile 600 further includes an activity profile 602 that contains a listing of applications 603 and/or application types 604 (e.g., Minecraft® with an application type of a game, Battle Bears® with an application type of a game) that when active cause messaging server 102 to prevent messages from being sent to the associated registered computing device 101.

Delivery profile 602 additionally includes a conversation profile 605 which includes a listing a conversation threads that are currently active on the associated registered computing device 101. In particular, conversation profile 605 includes a conversation thread identification 606 for each conversation thread as well as a listing 607 (identified as “Group” in FIG. 6) of the other users who are participating in the conversation thread and the time 608 that the conversation thread expires. For example, FIG. 6 illustrates conversation thread #1 with a participant of mike@example.com that expires at 12:15 PM EDT. FIG. 6 further illustrates conversation thread #2 with participants of john@example.com and mary@example.com that expires at 17:30 PM EDT.

Furthermore, delivery profile 602 includes an identification of the last activity and login 609. Such a profile 609 stores a time of the last login of the user of the registered computing device 101. Furthermore, profile 609 stores an identifier of the computing device 101 (e.g., 43254DK9J2) that the user of delivery profile 600 last used.

The information stored in delivery profile 600 may be used to control the delivery of messages to the registered computing device 101 as discussed further below.

Delivery profile 600 of FIG. 6 is not to be limited in scope to the information discussed above but may include any information that may be used to control the delivery of messages to the registered computing device 101. Furthermore, the illustration of FIG. 6 only depicts some of the information discussed herein that is utilized by messaging server 102 to control the delivery of messages to designated computing devices 101 for ease of understanding. Delivery profile 600 of FIG. 6 is not to be limited in scope to only the information illustrated in FIG. 6.

Returning to FIG. 4, in conjunction with FIGS. 1-3 and 5-6, in step 403, a determination is made by messaging server 102 as to whether a message from a sender has been received to be delivered to a user of a registered computing device 101. A “registered computing device 101,” as used herein, refers to a computing device 101 (e.g., client device 101A) that has been registered with messaging server 102 in step 401. A “sender,” as used herein, refers to a user of client device 101 sending a message (e.g., instant message, text message) that has been sent to messaging server 102 to be delivered to the intended recipient.

If messaging server 102 has not received a message to be delivered to a user of a registered computing device 101, then messaging server 102 continues to determine whether a message from a sender has been received to be delivered to a user of a registered computing device 101 in step 403.

If, however, messaging server 102 received a message to be delivered to a user of a registered computing device 101, then, in step 404, messaging server 102 reviews the delivery profiles 600 associated with the recipient of the message to receive a message from the sender. In step 405, a determination is made by messaging server 102 as to whether any of the recipient's computing devices 101 are able to receive the message from the sender. For example, if John is the intended recipient of the message, then the delivery profiles 600 for John iPhone® and John iPad® (see server registry 500) are reviewed to determine which, if any, of John's computing devices 101 are to receive a message from the sender. Other examples include determining in the delivery profiles 600 of the recipient's computing devices 101 whether the message to be delivered is of a type of message that can be received by the sender. The principles of the present invention include using any information that is stored in delivery profile 600, as discussed herein, to determine whether the message is able to be delivered to a registered computing device 101 of the intended recipient.

If none of the recipient's computing devices 101 are able to receive the message from the sender according to delivery profile 600, then, in step 406, messaging server 102 does not deliver the message to the recipient. For example, if the sender is not listed in sender profile 601 for any of the delivery profiles 600 of the registered computing devices 101 of the recipient, then the recipient is not eligible to receive a message from the sender.

If, however, a recipient's computing device 101 is able to receive the message from the sender according to delivery profile 600, then, in step 407, messaging server 102 delivers the message to a particular registered computing device 101 in response to delivery profile 600 for that registered computing device 101 indicating that the registered computing device 101 is able to receive the message from the sender. For example, if the sender is lark@domain.com, then, according to delivery profile 600, the registered computing device 101 associated with the identifier of 603RTJ343K20 is able to receive a message from the sender. In this manner, the user of computing devices 101 is able to control the delivery of messages to designated computing devices 101.

In step 408, messaging server 102 prevents the message from being delivered to other registered computing devices 101 of the recipient (those registered computing devices 101 that are not eligible to receive a message from the sender according to the delivery profiles 600 for these registered computing devices 101) that are actively receiving messages. For example, the registered computing device 101 associated with the identifier of 43254DK9J2 may not be able to receive messages from the sender lark@domain.com according to its associated delivery profile 600. In this manner, the user of computing devices 101 is able to control the delivery of messages to designated computing devices 101.

In step 409, messaging server 102 sends a message to the other registered computing devices 101 of the recipient (those registered computing devices 101 that are not eligible to receive a message from the sender according to the delivery profiles 600 for these registered computing devices 101) that are actively receiving messages to turn off the ability to receive messages from the sender.

After a conversation thread has started with a computing device 101, the user of the computing device 101 may desire to ensure that the conversation only continues on that computing device 101. A method for ensuring that the conversation continues on computing device 101 that was used during the start of the conversation thread is discussed below in connection with FIG. 7.

FIG. 7 is a flowchart of a method 700 for locking a registered computing device 101 to a communication thread in accordance with an embodiment of the present invention.

Referring to FIG. 7, in conjunction with FIGS. 1-6, in step 701, a determination is made by messaging server 102 as to whether the registered computing device 101 is engaged in a conversation with an individual or a group.

If the registered computing device 101 is not engaged in a conversation with an individual or a group, then messaging server 102 continues to determine whether the registered computing device 101 is engaged in a conversation with an individual or a group in step 701.

If, however, the registered computing device 101 is engaged in a conversation with an individual or a group, then, in step 702, a determination is made by messaging server 102 as to whether it received a designation from the user of the registered computing device 101 to only receive messages by the registered computing device 101 currently communicating with the sender.

If messaging server 102 has not received a designation from the user of the registered computing device 101 to only receive messages by the registered computing device 101 currently communicating with the sender, then messaging server 102 continues to determine whether it received a designation from the user of the registered computing device 101 to only receive messages by the registered computing device 101 currently communicating with the sender in step 702.

If, however, messaging server 102 received a designation from the user of the registered computing device 101 to only receive messages by the registered computing device 101 currently communicating with the sender, then, in step 703, messaging server 102 designates the registered computing device 101 currently communicating with the sender to only be receiving future messages in a current communication thread with the sender. In this manner, the user of computing devices 101 is able to control the delivery of messages to designated computing devices 101. As discussed herein, such a computing device 101 is said to be “locked” to the communication thread. In one embodiment, such a designation may be made in delivery profile 600 (not shown in FIG. 6).

In step 704, a determination is made by messaging server 102 as to whether the user of the registered computing device 101 designated a duration of time that the designated registered computing device 101 is to be locked to the conversation thread.

If the user did not designate a duration of time that the conversation thread is to be locked, then, in step 705, messaging server 102 locks the registered computing device 101 until the communication thread is specified as ended or for a default period of time.

If, however, the user designated a duration of time (e.g., until 17:30 pm) that the conversation thread is to be locked, then, in step 706, messaging server 102 locks the registered computing device 101 for the designated period of time. In one embodiment, the user of the registered computing device 101 may provide such designation via any of the input means discussed above in connection with FIG. 2.

An alternative method for controlling the delivering of messages to designated computing devices 101 is discussed below in connection with FIG. 8.

FIG. 8 is a flowchart of an alternative method 800 for controlling the delivering of messages to designated computing devices 101 in accordance with an embodiment of the present invention.

Referring to FIG. 8, in conjunction with FIGS. 1-3 and 5-6, in step 801, messaging server 102 receives the identifiers of the computing devices 101 to be registered from the user of the computing devices 101 and enable what is referred to herein as “application profiling.” For example, the user of client device 101A provides messaging server 102 the identifiers of two or more of the user's computing devices 101. In one embodiment, the identifier corresponds to a media access control (MAC) address. In one embodiment, such computing devices 101 are registered in a server registry 500 as illustrated in FIG. 5. “Application profiling,” as used herein, refers to the ability of using the activity of an application and/or an application type to determine whether a message is delivered to computing device 101 as discussed below.

In step 802, messaging server 102 receives a set of applications and/or application types associated with a registered computing device 101 to be stored in delivery profile 600 that when active will cause messages to be disabled from being sent to the registered computing device 101. For example, as illustrated in FIG. 6, delivery profile 600 includes activity profile 602 containing the applications and its associated application type. Hence, if application Minecraft® or Battle Bears® is active, then messaging server 102 will not send a message to computing device 101 associated with delivery profile 600. While delivery profile 600 illustrates using both the application and its associated application type for determining whether a message is to be delivered to computing device 101 associated with delivery profile 600, delivery profile 600 may only include a listing of the applications or a listing of the application types that are used to determine whether a message is to be delivered to computing device 101 associated with delivery profile 600.

In step 803, a determination is made by messaging server 102 as to whether it received an indication that any of the designated applications or application types is active. For example, the registered computing device 101 may send a message to messaging server 102 in response to one of these designated applications or application types being active.

If messaging server 102 did not receive an indication that any of the designated applications or application types is active, then messaging server 102 continues to determine whether any of the designated applications or application types is active in step 803.

If, however, messaging server 102 received an indication that a designated application or application type is active, then, in step 804, messaging server 102 marks the registered computing device 101 whose designated application or application type is active as not being available for receiving messages. In one embodiment, such designation may be made in delivery profile 600 (not shown in FIG. 6).

In step 805, messaging server 102 prevents messages from being sent to the marked registered computing device 101 whose designated application and/or application type is active. In this manner, the user of computing devices 101 is able to control the delivery of messages to designated computing devices 101.

In step 806, a determination is made by messaging server 102 as to whether it received an indication that the application or application type is no longer active for a period of time. In one embodiment, the registered computing device 101 may send a message to messaging server 102 indicating that the application or application type is no longer active for a period of time in response to one of these designated applications or application types no longer being active for a period of time.

If messaging server 102 did not receive an indication that the application or application type is no longer active for a period of time, then messaging server 102 continues to determine whether it received an indication that the application or application type is no longer active for a period of time in step 806.

If, however, messaging server 102 received an indication that the application or application type is no longer active for a period of time, then, in step 807, messaging server 102 re-enables messaging to the registered computing device 101. In one embodiment, messaging server 102 may indicate that messaging is re-enabled in delivery profile 600 (not shown in FIG. 6).

A further alternative method for controlling the delivering of messages to designated computing devices 101 is discussed below in connection with FIG. 9.

FIG. 9 is a flowchart of an alternative method 900 for controlling the delivering of messages to designated computing devices 101 in accordance with an embodiment of the present invention.

Referring to FIG. 9, in conjunction with FIGS. 1-3 and 5-6, in step 901, messaging server 102 receives the identifiers of computing devices 101 to be registered along with message delivery information from the user (e.g., user of client device 101A) which contains details of criteria as to which computing device 101 should receive a designated message from a designated contact (such as a contact in the user's contact list). For example, the user of client device 101 may provide messaging server 102 a list of identifiers (e.g., identifier numbers 43254DK9J2 and 603RTJ343K20) to be registered, such as in server registry 500, along with message delivery information which contains details of criteria as to which computing device 101 (e.g., computing device 101 associated with identifier number 603RTJ343K20) should receive a designated message type (e.g., instant message) from a designated contact (e.g., lark@domain.com).

In step 902, messaging server 102 receives a list of designated contacts (e.g., list of the user's friends in the user's contact list) who are authorized to obtain a list of the registered computing devices 101 from the user.

In step 903, messaging server 102 sends the device identifiers and associated message delivery options to each contact in the list of designated contacts.

In step 904, the user (recipient of the device identifiers and associated message delivery options) (e.g., user of client device 101B who is a contact of the user of client device 101A) integrates the received device identifiers and associated message delivery options in the user's contact list. In this manner, the user can control the delivery of messages to designated computing devices 101 when the user is sending a message as discussed below in connection with FIG. 10.

FIG. 10 is a flowchart of a method 1000 for the sender to designate a computing device 101 to receive a composed message in accordance with an embodiment of the present invention.

Referring to FIG. 10, in conjunction with FIGS. 1-3, 5-6 and 9, in step 1001, computing device 101 (e.g., computing device 101B) receives a designated recipient to receive a message (e.g., instant message, text message) being composed by a sender (e.g., user of computing device 101B). For example, the user of computing device 101B may indicate in the “TO:” field of a composed message to send the message to a designated recipient. In one embodiment, the user may enter such information via any input means as discussed above in connection with FIG. 2.

In step 1002, computing device 101 (e.g., computing device 101B) receives a designated computing device 101 of the designed recipient to receive the message being composed by the sender. In one embodiment, the sender may be provided with a list of computing devices 101 utilized by the selected recipient along with the designated message types that each computing device 101 is authorized to receive. Such information may be provided to the sender via a drop down menu. As discussed above, in connection with step 904 of method 900, computing device 101 of the sender possesses such information via the integration of the recipient's device identifiers and associated message delivery options in the sender's contact list.

In step 1003, computing device 101 (e.g., computing device 101B) delivers the message being composed by the sender (e.g., user of computing device 101B) to the designated computing device 101 (e.g., computing device 101A) of the designated recipient (e.g., user of computing device 101A). In this manner, the sender of a message is able to control the delivery of messages to designated computing devices 101.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for controlling a delivery of messages to designated computing devices, the method comprising:
receiving identifiers of computing devices to be registered from a user;
receiving, by a processor, message delivery information from said user to create a profile for each registered computing device which contains details of criteria as to whether said registered computing device is able to receive a message from a sender;
delivering a message received from said sender to a registered computing device in response to said associated profile indicating that said registered computing device is able to receive said message from said sender; and
preventing said message from being delivered to one or more other registered computing devices of said user that are actively receiving messages that are not eligible to receive said message from said sender according to said associated one or more profiles.

2. The method as recited in claim 1 further comprising:
sending a message to one or more other registered computing devices of the user that are actively receiving messages that are not eligible to receive the message from the sender according to the associated one or more profiles to turn off ability to receive messages from the sender

3. The method as recited in claim 1 further comprising:
receiving a designation from said user to only receive messages by said registered computing device currently communicating with said sender;
designating said registered computing device currently communicating with said sender to only be receiving future messages in a current communication thread with said sender; and
locking said registered computing device to said communication thread until said communication thread is specified as ended or for a default period of time.

4. The method as recited in claim 1 further comprising:
receiving a designation from said user to only receive messages by said registered computing device currently communicating with said sender;
designating said registered computing device currently communicating with said sender to only be receiving future messages in a current communication thread with said sender; and
locking said registered computing device to said communication thread for a designated period of time provided by said user.

5. The method as recited in claim 1 further comprising:
receiving a set of applications or application types associated with said registered computing device to be stored in said associated profile that when active will cause messages to be disabled from being sent to said registered computing device;
receiving a message that an application or an application type in said set of applications or application types is active;
marking said registered device whose application or application type is active as not being available for receiving messages; and
preventing messages from being sent to said registered device in response to marking said registered device whose application or application type is active as not being available for receiving messages.

6. The method as recited in claim 5 further comprising:
re-enabling messaging to said registered device in response to said application or application type not being active for a period of time.

7. The method as recited in claim 1, wherein said message delivery information comprises specifying whether messages are to be sent to a most recently used registered computing device, wherein said message delivery information further comprises specifying whether messages from a particular sender are to be received by only a single registered computing device, wherein said message delivery information further comprises specifying a listing of designated message types to be delivered from designated senders.

8. The method as recited in claim 1, wherein said message delivery information comprises specifying whether to keep a conversation thread started on said registered computing device on only that registered computing device until said conversation thread is specified as being completed or for a default period of time.

9. The method as recited in claim 1, wherein said message is an instant message or a text message.

10. A computer program product for controlling a delivery of messages to designated computing devices, the computer program product comprising a computer readable storage medium having program code embodied therewith, the program code comprising the programming instructions for:
receiving identifiers of computing devices to be registered from a user;
receiving message delivery information from said user to create a profile for each registered computing device which contains details of criteria as to whether said registered computing device is able to receive a message from a sender;
delivering a message received from a sender to a registered computing device in response to said associated profile indicating that said registered computing device is able to receive said message from said sender; and
preventing said message from being delivered to one or more other registered computing devices of said user that are actively receiving messages that are not eligible to receive said message from said sender according to said associated one or more profiles.

11. The computer program product as recited in claim 10, wherein the program code further comprises the programming instructions for:
receiving a designation from said user to only receive messages by said registered computing device currently communicating with said sender;
designating said registered computing device currently communicating with said sender to only be receiving future messages in a current communication thread with said sender; and
locking said registered computing device to said communication thread until said communication thread is specified as ended or for a default period of time.

12. The computer program product as recited in claim 10, wherein the program code further comprises the programming instructions for:
receiving a designation from said user to only receive messages by said registered computing device currently communicating with said sender;
designating said registered computing device currently communicating with said sender to only be receiving future messages in a current communication thread with said sender; and
locking said registered computing device to said communication thread for a designated period of time provided by said user.

13. The computer program product as recited in claim 10, wherein the program code further comprises the programming instructions for:
receiving a set of applications or application types associated with said registered computing device to be stored in said associated profile that when active will cause messages to be disabled from being sent to said registered computing device;
receiving a message that an application or an application type in said set of applications or application types is active;
marking said registered device whose application or application type is active as not being available for receiving messages; and
preventing messages from being sent to said registered device in response to marking said registered device whose application or application type is active as not being available for receiving messages.

14. The computer program product as recited in claim 13, wherein the program code further comprises the programming instructions for:
re-enabling messaging to said registered device in response to said application or application type not being active for a period of time.

15. The computer program product as recited in claim 10, wherein said message delivery information comprises specifying whether messages are to be sent to a most recently used registered computing device, wherein said message delivery information further comprises specifying whether messages from a particular sender are to be received by only a single registered computing device, wherein said message delivery information further comprises specifying a listing of designated message types to be delivered from designated senders.

16. The computer program product as recited in claim 10, wherein said message delivery information comprises specifying whether to keep a conversation thread started on said registered computing device on only that registered computing device until said conversation thread is specified as being completed or for a default period of time.

17. The computer program product as recited in claim 10, wherein said message is an instant message or a text message.

18. A method for controlling a delivery of messages to designated computing devices, the method comprising:
receiving a designated recipient to receive a message being composed by a sender;
receiving, by a processor, a designated computing device of said designed recipient to receive said message being composed by said sender; and
delivering said message being composed by said sender to said designated computing device of said designated recipient.

19. The method as recited in claim 18 further comprising:
receiving identifiers of computing devices to be registered along with message delivery information which contains details of criteria as to which computing device should receive a designated message from a designated contact;
receiving a list of designated contacts authorized to obtain a list of said registered computing devices; and
sending said identifiers of said computing devices and associated message delivery information to each contact in said list of designated contacts, wherein said identifiers of said computing devices and associated message delivery information are integrated in contact lists of said designated contacts.

20. The method as recited in claim 18, wherein said message is an instant message or a text message.
